(19) United States
(12) Patent Application Publication
(10) Pub. No.: US 2019/0308177 A1
(43) Pub. Date: Oct. 10, 2019

(54) FUEL CELL ELECTRODE, FUEL CELL, AND CATALYST BODY

(71) Applicant: DENSO CORPORATION, Kariya-city, Aichi-pref. (JP)

(72) Inventors: Ryota SHINOZAKI, Kariya-city (JP); Tomoya ITAKURA, Kariya-city (JP); Yoshimasa HIJIKATA, Kariya-city (JP)

(21) Appl. No.: 16/309,594

(22) PCT Filed: May 9, 2017
(86) PCT No.: PCT/JP2017/017510

§ 371 Date: Dec. 13, 2018

(30) Foreign Application Priority Data
Jun. 16, 2016 (JP) 2016-119880

(51) Int. Cl. B01J 31/06; H01M 4/88; H01M 8/102; H01M 8/1051; H01M 8/1067; H01M 4/90

(52) U.S. Cl. CPC B01J 31/06; H01M 4/88; H01M 8/102; B82Y 30/00; H01M 8/1067; H01M 4/9083; H01M 8/1051

(57) ABSTRACT

A fuel cell electrode includes an intra-electrode proton conductor and a catalyst. The intra-electrode proton conductor contains a metal ion, an oxoanion, and a proton coordinating molecule, and at least one of an oxoanion and a proton coordinating molecule coordinates to the metal ion to form a coordination polymer. The intra-electrode proton conductor is disposed in contact with the catalyst. For example, the catalyst is covered with the intra-electrode proton conductor.

### CROSS REFERENCE TO RELATED APPLICATION

This application is based on Japanese Patent Application No. 2016-119880 filed on Jun. 16, 2016, the contents of which are incorporated herein by reference.

### TECHNICAL FIELD

The present disclosure relates to a fuel cell electrode, a fuel cell, and a catalyst body.

From the viewpoints of lower cost of solid polymer electrolyte fuel cell systems and simplification of the systems, it is expected an electrolyte material that operates at an operating temperature of 100° C. or higher and under conditions of no humidity or low humidity. On the other hand, a conventional solid polymer electrolyte fuel cell has an electrolyte that conducts ions through water as represented by perfluorocarbon sulfonic acid. Therefore, it is difficult to exhibit sufficient ion conductivity under the operating condition of 100° C. or more, and no humidity or low humidity.

On the other hand, it has been proposed to use a conductive film including a coordination polymer (CP) as an electrolyte material in order to enable the operation under the condition of 100° C. or higher and no humidity (see Patent Literature 1).

### PRIOR ART LITERATURE

### Patent Literature

Patent Literature 1: JP 2016-4621 A

### SUMMARY

In a fuel cell, an intra-electrode proton conductor for forming a proton conduction path is generally provided in a catalyst layer for the purpose of obtaining a high-performance electrode capable of effectively utilizing a wide range inside the catalyst layer as a reaction point. In order to stably operate the fuel cell using the coordination polymer described in Patent Literature 1 at 100° C. or higher, an intra-electrode proton conductor usable at a high temperature of 100° C. or higher is required.

It is an object of the present disclosure to provide a fuel cell electrode, which exhibits high performance even at a high temperature, a fuel cell having the fuel cell electrode and operating at a high temperature, and a catalyst body.

According to a first aspect of the present disclosure, a fuel cell electrode includes an intra-electrode proton conductor and a catalyst. The intra-electrode proton conductor includes a metal ion, an oxoanion, and a proton coordinating molecule, and at least one of the oxoanion and the proton coordinating molecule coordinates to the metal ion to form a coordination polymer. The intra-electrode proton conductor is disposed to be in contact with the catalyst.

As described above, the fuel cell electrode has a proton conductor made of the coordination polymer as the intra-electrode proton conductor. Therefore, the fuel cell electrode can achieve higher performance even when a fuel cell operates at a high temperature of 100° C. or higher.

According to a second aspect of the present disclosure, the fuel cell electrode according to the first aspect forms a fuel cell together with an electrolyte made of a proton conductor forming a coordination polymer. As such, the similar effects as described above can be achieved.

According to a third aspect of the present disclosure, a catalyst body includes a coordination polymer and a catalyst. The coordination polymer includes a metal ion, an oxoanion, and a proton coordinating molecule, and at least one of the oxoanion and the proton coordinating molecule coordinates to the metal ion. A proton conductor covers the catalyst. As such, the catalyst body can exhibit high performance even at a high temperature.

### BRIEF DESCRIPTION OF THE DRAWINGS

The above object, the other objects, features, and advantages of the present disclosure will become more apparent from the following detailed description with reference to the accompanying drawings, in which:

FIG. 1 is a conceptual diagram showing a configuration of a fuel cell;

FIG. 2 is an enlarged view of a part of a catalyst layer;

FIG. 3 is a view showing a procedure of preparing a catalyst layer;

FIG. 4A is a TEM image of a catalyst layer; and

FIG. 4B is an enlarged image of a portion surrounded by a broken line IVB in FIG. 4A.

### DETAILED DESCRIPTION

Hereinafter, an embodiment of the present disclosure will be described with reference to the drawings.

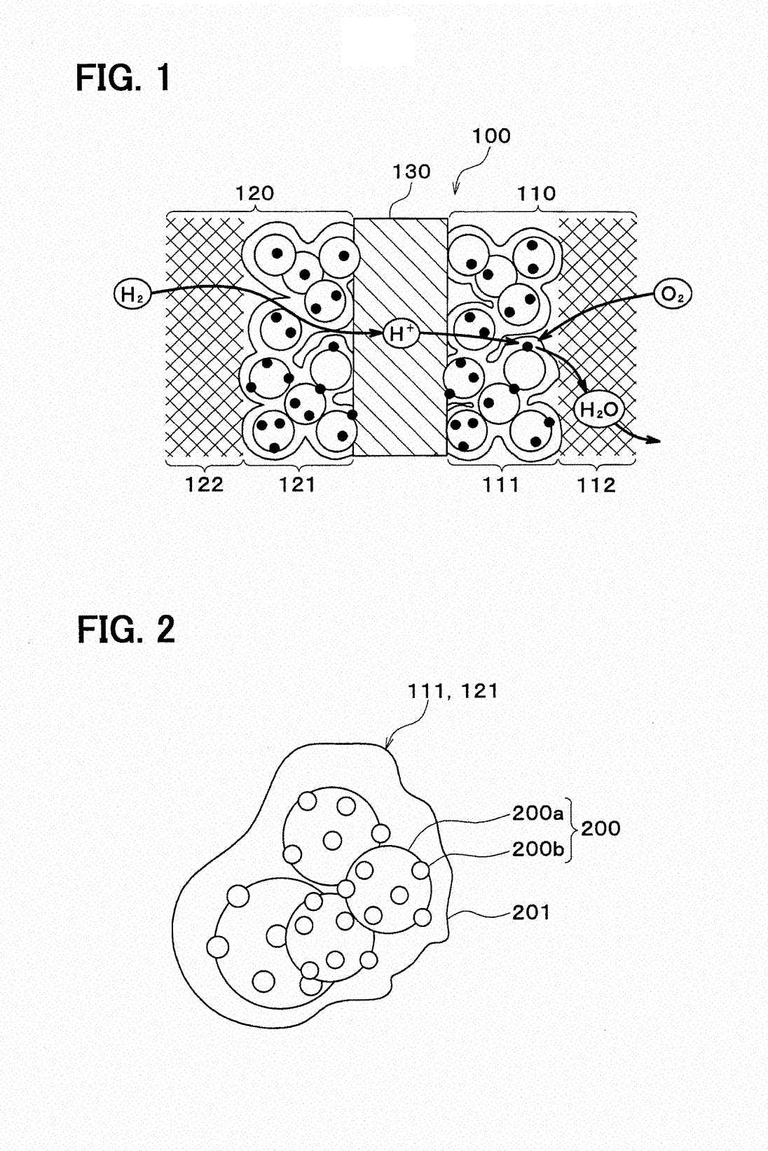

As shown in FIG. 1, a fuel cell 100 includes a cathode 110, an anode 120, and an electrolyte membrane 130. Note that the cathode 110 is also referred to as an air electrode and the anode 120 is also referred to as a hydrogen electrode. The cathode 110 and the anode 120 correspond to electrodes for a fuel cell.

The fuel cell 100 outputs electric energy using an electrochemical reaction between a fuel gas (hydrogen) and an oxidant gas (oxygen in air). The fuel cell 100 is provided as a basic unit, and a plurality of the fuel cells 100 can be stacked as a stack structure to be used.

When the fuel cell 100 is supplied with a reaction gas such as hydrogen and air, hydrogen and oxygen electrochemically react with each other to output the electric energy as described below.

H₂→2H⁺+2e⁻ (Anode Side)

2H⁺+½O₂+2e⁻→H₂O (Cathode Side)

In this case, in the anode electrode 120, hydrogen is ionized into electron (e⁻) and proton (H⁺) by the catalytic reaction, and the proton (H⁺) moves through the electrolyte membrane 130. On the other hand, in the cathode 110, the protons (H⁺) migrating from the anode 120, electrons flowing from the outside, and oxygen (O₂) in the air react with each other to generate water.

The cathode 110 is made of a cathode catalyst layer 111 and a cathode diffusion layer 112. The cathode catalyst layer 111 is disposed in close contact with an air electrode side surface of the electrolyte membrane 130. The cathode diffusion layer 112 is arranged on an outer side of the cathode catalyst layer 111.

The anode electrode 120 is made of an anode catalyst layer 121 and an anode diffusion layer 122. The anode catalyst layer 121 is disposed in close contact with a hydrogen electrode side surface of the electrolyte membrane 130. The anode diffusion layer 122 is disposed on an outer side of the anode catalyst layer 121.

Each of the catalyst layers 111 and 121 is formed of a catalyst-carrying carbon or the like having a carbon carrier carrying a catalyst (platinum or the like) that promotes an electrochemical reaction. Each of the diffusion layers 112 and 122 is formed of carbon cloth or the like. The catalyst layers 111 and 121 will be described later in detail.

The electrolyte membrane 130 is made of a proton conductor containing a metal ion, an oxoanion and a proton coordinating molecule. In the proton conductor, at least one of the oxoanion and the proton coordinating molecule is coordinated to the metal ion to form a coordination polymer (CP).

The metal ion contained in the proton conductor is not particularly limited. However, from the viewpoint of ease of forming a coordination bond with the oxoanion and/or the proton coordinating molecule, a transition metal ion with higher periodic number and a typical metal ion are preferable. Of the above metal ions, cobalt ions, copper ions, zinc ions, and gallium ions are preferable. In the electrolyte membrane 130 of the present embodiment, the zinc ion is used as the metal ion.

As the oxoanion contained in the proton conductor, for example, phosphate ion, sulfate ion and the like can be mentioned. From the viewpoint of chemical stability against hydrogen, the phosphate ion is preferable. In the electrolyte membrane 130 of the present embodiment, the phosphate ion is used as the oxoanion.

The phosphate ion may be in the form of hydrogen phosphate ion to which one proton is coordinated or dihydrogen phosphate ion to which two protons are coordinated. The oxoanion is coordinated to the metal ion in the form of, for example, a monomer without undergoing condensation. In such a case, it is retained in a state where the proton concentration is high, and is also excellent in stability against moisture.

The proton coordinating molecule contained in the proton conductor is a molecule having preferably two or more coordination sites for coordinating protons in the molecule. From the viewpoint of ionic conductivity, imidazole, triazole, benzimidazole, benzotriazole, and derivatives thereof, which have coordination sites excellent in the balance between proton coordination and emission, are preferable. In the electrolyte membrane 130 of the present embodiment, imidazole is used as the proton coordinating molecule.

The derivative means one in which a part of the chemical structure is replaced by another atom or atomic group. Specific examples of the derivatives include 2-methylimidazole, 2-ethylimidazole, histamine, histidine and the like, in regard to the imidazole.

As the proton coordinating molecule, for example, a primary amine represented by the general formula of R—NH₂, a secondary amine represented by the general formula of R¹ (R²)—NH, a tertiary amine represented by a general formula R¹ (R²) (R³)—N may be used. Here, each of R, R¹, R² and R³ is independently any one of an alkyl group, an aryl group, an alicyclic hydrocarbon group, and a heterocyclic group.

Examples of the primary amine include lower alkylamines such as methylamine, ethylamine, and propylamine, and an aromatic amine such as aniline and toluidine. Examples of the secondary amine include di-lower alkyl amines such as dimethylamine, diethylamine, and dipropylamine, and aromatic secondary amines such as N-methylaniline, and N-methyltoluidine. Examples of the tertiary amine include tri-lower alkyl amines such as trimethylamine and triethylamine.

Examples of the proton coordinating molecule include carbon-straight chain diamines such as ethylenediamine and N-lower alkyl derivative thereof (e.g., tetramethylethylenediamine).

Examples of proton coordinating molecules include saturated cyclic amines, such as pyrrolidine, N-lower alkylpyrrolidine (e.g., N-methylpyrrolidine), piperidine, N-lower alkylpiperidine (e.g., N-methylpiperidine), morpholine, and N-lower alkylmorpholine (e.g., N-methyl morpholine).

Examples of the proton coordinating molecule include saturated cyclic diamines such as piperazine, N-lower dialkylpiperazine (e.g., N, N-dimethylpiperazine), and 1,4-diazabicyclo [2.2.2] octane (also called as triethylenediamine).

In regard to the mixing ratio of each constituent element of the proton conductor (that is, the metal ion, the oxoanion and the proton coordinating molecule), it is preferable that the oxoanion is 1 to 4 mole relative to 1 mole of the metal ion, and the proton coordinating molecule is 1 to 3 mole relative to 1 mole of the metal ion so that each constituent element efficiently forms a coordination polymer. If the oxoanion and the proton coordinating molecule are each less than 1 mole, coordination polymer may not be formed in some cases. In a case where more than 4 mole of the oxoanions are blended and in a case where more than 3 moles of the proton coordinating molecule is blended, the proton conductor is not in a solid state, and exhibits very high hygroscopicity, resulting in a remarkable decrease of stability in shape.

The proton conductor is obtained by mixing and agitating the metal oxide as a metal ion source, an oxoacid, and the proton coordinating molecule. In the step of mixing and agitating, a solvent capable of dissolving or uniformly dispersing each raw material can be used. However, in the viewpoint of production cost, it is preferable to carry out the step of mixing and agitating through the reaction without solvent. In addition, in the above-described manufacturing process, if the proton conductor is heat-treated at a temperature higher than 200° C., condensation of phosphate ions contained therein may occur. Therefore, it is preferable to perform the heat-treatment at a temperature of 200° C. or lower.

The proton conductor may contain an additive material in addition to the metal ion, the oxoanion, and the proton coordinating molecule. Examples of the additive material include one or more selected from the group consisting of a metal oxide, an organic polymer, and an alkali metal ion. When these additive materials are contained, the ionic conductivity at a low temperature (e.g., less than 100° C.) is further increased without deteriorating the performance of the proton conductor at a high temperature (e.g., 100° C. or higher).

The addition amount of the additive material is preferably in the range of 1 to 20 parts by weight when the total weight of the metal ion, the oxoanion, and the proton coordinating molecule is 100 parts by weight. In a case where the additive material is a metal oxide or an organic polymer, the addition amount of the additive material is preferably in the range of 5 to 20 parts by weight. When the addition amount of these additive materials is within this range, the ionic conductivity at a low temperature (e.g., less than 100° C.) is further increased without deteriorating the performance of the proton conductor at a high temperature (e.g., 100° C. or higher).

Examples of the metal oxide as the additive material include one or more selected from the group consisting of SiO₂, TiO₂, Al₂O₃, WO₃, MoO₃, ZrO₂, and V₂O₅. When these metal oxides are used, the ionic conductivity at a low temperature (e.g., less than 100° C.) is further increased without deteriorating the performance of the proton conductor at a high temperature (e.g., 100° C. or higher). The particle size of the metal oxide is preferably in the range of 5 to 500 nm. When the particle size is within this range, the ionic conductivity at a low temperature (e.g., less than 100° C.) is further increased without deteriorating the performance of the proton conductor at a high temperature (e.g., 100° C. or higher). The particle size is a value obtained by taking a photograph of particles of a metal oxide with an electron microscope (SEM) and image-analyzing the obtained image.

The organic polymer as the additive material preferably has an acidic functional group. When the organic polymer having the acidic functional group is used, the ionic conductivity at a low temperature (e.g., less than 100° C.) is further increased without deteriorating the performance of the proton conductor at a high temperature (e.g., 100° C. or higher). Examples of the acidic functional group include any of a carboxyl group (—COOH), a sulfonic acid group (—SO₃H), and a phosphonic acid group (—PO₃H₂). The organic polymer has pH preferably in the range of 4 or less. When the pH of the organic polymer is within this range, the ionic conductivity at a low temperature (e.g., less than 100° C.) is further increased without deteriorating the performance of the proton conductor at a high temperature (e.g., 100° C. or higher).

Examples of the organic polymer include polyacrylic acid (PAA), polyvinylphosphonic acid (PVPA), polystyrenesulfonic acid (PSSA), and deoxyribonucleic acid (DNA).

Examples of the alkali metal ion as the additive material include one or more kinds of metal ions selected from the group consisting of Li, Na, K, Rb, and Cs. When these alkali metals are used, the ionic conductivity of the proton conductor is further increased at a low temperature (e.g., less than 100° C.) and at a high temperature (e.g., 100° C. or higher).

In the case of including the above-described additive material, the proton conductor is, for example, obtained by mixing and agitating a metal oxide as a meal ion source, an oxoacid, a proton coordinating molecule, and an additive material. In the mixing and agitating, it is preferable to mix and agitate all the raw materials at once.

In the step of mixing and agitating, a solvent capable of dissolving or uniformly dispersing each raw material can be used. However, in the viewpoint of production cost, it is preferable to carry out the mixing and agitating through the reaction without solvent. In addition, in the above-described manufacturing process, when the proton conductor is heat-treated at a temperature higher than 200° C., condensation of phosphate ions contained therein may occur. Therefore, it is preferable to perform the heat-treatment at a temperature of 200° C. or lower.

Next, the configuration of the catalyst layers 111 and 121 will be described with reference to FIG. 2.

The catalyst layers 111 and 121 includes a catalyst-supporting carbon 200. The catalyst-supporting carbon 200 has a carbon carrier 200a and platinum particles 200b supported on the carbon carrier 200a. The carbon carrier 200a is a carbon fine powder, which is called as carbon black. The platinum particles 200b, which are fine particles of platinum, are carried on the surface of the carbon carrier 200a. Note that the catalyst-supporting carbon 200 corresponds to a catalyst.

The catalyst-supporting carbon 200 is covered with an ionomer 201. The ionomer 201 is an electrolyte having proton conductivity. Note that the ionomer 201 corresponds to the intra-electrode proton conductor of the present disclosure.

The ionomer 201 of the present embodiment is made of an electrolyte that is composed of the same type of coordination polymer as the electrolyte membrane 130 described above. That is, the ionomer 201 is made of a proton conductor containing a metal ion, an oxoanion and a proton coordinating molecule. In the proton conductor, at least one of the oxoanion and the proton coordinating molecule is coordinated to the metal ion to form a coordination polymer. The metal ion, oxoanion and proton coordinating molecule contained in the coordination polymer are the same as those of the electrolyte membrane 130 described above.

The thickness of the ionomer 201 covering the catalyst-supporting carbon 200 is preferably in the range of 3 to 50 nm, and more preferably in the range of 5 to 50 nm. If the ionomer 201 is too thin, the crystallinity of the coordination polymer cannot be maintained and the proton conductivity may be lost. Therefore, the thickness of the ionomer 201 is preferably 3 nm or more, more preferably 5 nm or more. Also, if the ionomer 201 is too thick, the oxygen permeability may decrease, and the proportion occupied by the ionomer 201 in the catalyst layers 111, 121 results in too large. Therefore, the thickness of the ionomer 201 is preferably 50 nm or less.

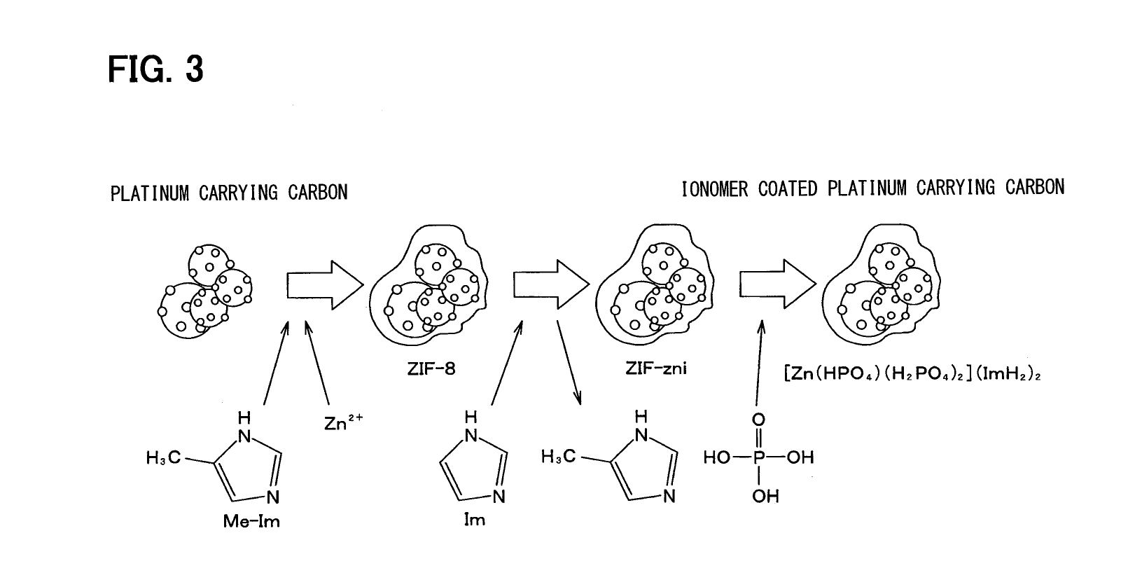

Next, a method of coating the catalyst-supporting carbon 200 with the ionomer 201 will be described with reference to FIG. 3.

Firstly, particulate catalyst-supporting carbon 200 is suspended in a solvent. As the solvent, for example, methanol can be used.

Next, methylimidazole and zinc oxide (that is, zinc ion), which are raw materials of a coordination polymer precursor, are introduced into the solvent. As a result, the surface of the catalyst-supporting carbon 200 is covered with the coordination polymer precursor.

Next, imidazole is introduced into the solvent, and methylimidazole of the coordination polymer precursor is substituted with imidazole. Then, phosphoric acid is introduced into the solvent. In this way, the coordination polymer precursor coating the catalyst-supporting carbon 200 can be substituted with the coordination polymer as the target.

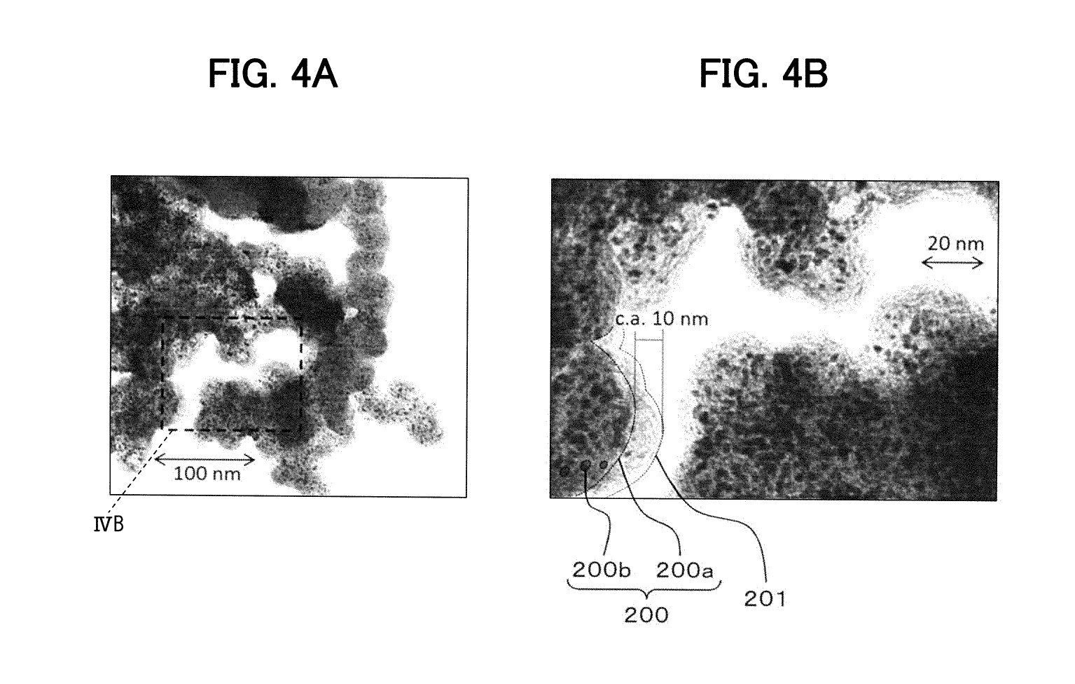

FIG. 4A is a transmission electron microscope (TEM) image of the product prepared by the procedure described above, and FIG. 4B is an enlarged image of the part surrounded by a broken line IVB in FIG. 4A. As shown in FIG. 4A and FIG. 4B, it was confirmed that the catalyst-supporting carbon 200 is covered with the ionomer 201.

Further, the granular catalyst-supporting carbon 200 covered with the ionomer 201 is dispersed in a solvent (for example, ethanol or propanol) to form an ink. This ink is applied onto a carbon cloth constituting the diffusion layers 112 and 122 and dried. In this way, the catalyst layers 111 and 121 and the diffusion layers 112 and 122 can be obtained.

According to the present embodiment as described above, in the catalyst layers 111 and 121 of the fuel cell 100, the ionomer 201 covering the catalyst-supporting carbon 200 is provided by the electrolyte made of the coordination polymer. Therefore, the catalyst layers 111 and 121 can be stably used even when the fuel cell 100 operates at a high temperature of 100° C. or higher.

### Other Embodiments

The present disclosure is not limited to the embodiment described hereinabove, but may be modified in various ways as hereinafter without departing from the gist of the present disclosure. Means disclosed in each embodiment described hereinabove may be appropriately combined within a range that can be implemented.

(1) In the above-described embodiment, the ionomer 201 of the catalyst layers 111 and 121 is provided by the electrolyte made of the coordination polymer of the same type as the electrolyte membrane 130. However, the present disclosure is not limited to the described embodiment, and the ionomer 201 may be provided by an electrolyte made of a coordination polymer of a different type of the electrolyte membrane 130. That is, the coordination polymer forming the ionomer 201 may have a different metal ion, oxoanion, or proton coordinating molecule from those of the coordination polymer forming the electrolyte membrane 130.

(2) In the above-described embodiment, the electrolyte membrane 130 is provided by the electrolyte made of a coordination polymer, but the electrolyte membrane 130 may be provided by an electrolyte other than the coordination polymer. The present disclosure can be applied to any fuel cell that operates at a high temperature of 100° C. or higher.

(3) In the above-described embodiment, it is not always necessary that the catalyst-supporting carbon 200 is entirely covered with the ionomer 201, and the catalyst-supporting carbon 200 may have a portion without covered with the ionomer 201. Further, it is not limited to the configuration in which the catalyst-carrying carbon 200 is covered with the ionomer 201, and the ionomer 201 may be provided at least to be in contact with the catalyst-supporting carbon 200. For example, the catalyst layers 111 and 121 may be formed by kneading granular ionomer 201 and granular catalyst-carrying carbon 200.

(4) In the above-described embodiment, the catalyst-supporting carbon 200 is directly covered with the intra-electrode proton conductor 201, but it is not limited thereto. The catalyst-supporting carbon 200 may be covered with a material other than the coordination polymer, and then covered thereon with the intra-electrode proton conductor made of the coordination polymer. The material other than the coordination polymer is not particularly limited as long as it is a material that does not inhibit proton transfer between the proton conductor made of the coordination polymer and the catalyst-supporting carbon 200, and may be a material that has a proton conductivity and mediates the proton transfer between the proton conductor made of the coordination polymer and the catalyst-supporting carbon 200.

As the materials other than the coordination polymer covering the catalyst-supporting carbon 200, for example, a proton conductive material such as a sulfonic acid polymer and a phosphoric acid polymer, or an ionic metal oxide can be used. As examples of the ionic metal oxide, alumina (Al₂O₃), tantalum oxide (Ta₂O₅), zirconium oxide (ZrO₂), iron oxide (Fe₂O₃, FeO, Fe₃O₄), chromium oxide (Cr₂O₃), niobium oxide (Nb₂O₃), manganese oxide (MnO, Mn₂O₃, MnO₂, Mn₃O₄), vanadium oxide (VO, VO₂, V₂O₅), titanium oxide (TiO, TiO₂), hafnium oxide (HfO₂), and scandium oxide (Sc₂O₃) can be used.

(5) In the above-described embodiment, the fuel cell electrodes (catalyst layers 111 and 121) are provided by the catalyst body in which the catalyst-supporting carbon 200 is covered with the ionomer 201, but the present disclosure is not limited thereto. The catalyst body in which the catalyst-supporting carbon 200 is covered with the ionomer 201 may be used for any applications other than the electrodes for fuel cells. Examples of the applications other than the electrodes for the fuel cells include gas reaction catalysts. In such cases, proton conductivity may be unnecessary in the catalyst body depending on the application.

(6) In the above-described embodiment, the catalyst-supporting carbon 200 is configured to be covered with the ionomer 201, but it is not always necessary that the catalyst-supporting carbon 200 is entirely covered with the ionomer 201. The catalyst-carrying carbon 200 may be supported on the ionomer 201. For example, the particles of the catalyst-supporting carbon 200 may be supported on the particles of the ionomer 201. As further another example, the carbon carrier 200a and the platinum particles 200b may be carried as separate particles on the particles of the ionomer 201 .

What is claimed is:

1. A fuel cell electrode comprising:
an intra-electrode proton conductor containing a metal ion, an oxoanion, and a proton coordinating molecule, at least one of the oxoanion and the proton coordinating molecule coordinating to the metal ion to form a coordination polymer; and
a catalyst, wherein
the intra-electrode proton conductor is disposed to be in contact with the catalyst,
the catalyst is covered with the intra-electrode proton conductor, and
the intra-electrode proton conductor covering the catalyst has a thickness in a range of 3 to 50 nm.

2. (canceled)

3. (canceled)

4. The fuel cell electrode according to claim 1, wherein the oxoanion is a monomer.

5. The fuel cell electrode according to claim 1, wherein
the oxoanion is one or more selected from the group consisting of a phosphate ion, a hydrogen phosphate ion, and a dihydrogen phosphate ion.

6. The fuel cell electrode according to claim 1, wherein
the proton-coordinating molecule is one or more selected from the group consisting of imidazole, triazole, benzimidazole, benzotriazole, and derivatives thereof.

7. The fuel cell electrode according to claim 1, wherein
the proton coordinating molecule is one or more selected from the group consisting of a primary amine represented by a general formula of R—NH₂, a secondary amine represented by a general formula of R¹ (R²)—NH, a tertiary amine represented by a general formula of R¹ (R²) (R³)—N , a carbon straight-chain diamine, a saturated cyclic amine, and a saturated cyclic diamine, wherein R, R¹, R² and R³ in the general formulas are each independently any of an alkyl group, an aryl group, an alicyclic hydrocarbon group, and a heterocyclic group.

8. The fuel cell electrode according to claim 1, wherein
the metal ion is one or more selected from the group consisting of a cobalt ion, a copper ion, a zinc ion, and a gallium ion.

9. The fuel cell electrode according to claim 1, wherein
the intra-electrode proton conductor includes one or more additive materials selected from the group consisting of a metal oxide, an organic polymer, and an alkali metal ion.

10. A fuel cell comprising:
the fuel cell electrode according to claim 1; and
an electrolyte made of a proton conductor forming the coordination polymer.

11. A catalyst body comprising:
a coordination polymer containing a metal ion, an oxoanion, and a proton coordinating molecule, at least one of the oxoanion and the proton coordinating molecule coordinating to the metal ion; and
a catalyst, wherein
the coordination polymer covers the catalyst, and
the coordination polymer covering the catalyst has a thickness in a range of 3 to 50 nm.
